(19) United States
(12) Patent Application Publication
(10) Pub. No.: US 2025/0337464 A1
(43) Pub. Date: Oct. 30, 2025

(54) PHASED ARRAY TRANSCEIVERS WITH SIMULTANEOUS SPATIAL AND FREQUENCY FILTERING

(71) Applicant: Saeed ZEINOLABEDINZADEH, Chandler, AZ (US)

(72) Inventor: Saeed ZEINOLABEDINZADEH, Chandler, AZ (US)

(73) Assignee: Arizona Board of Regents on behalf of Arizona State University, Scottsdale, AZ (US)

(21) Appl. No.: 19/190,547

(22) Filed: Apr. 25, 2025

Related U.S. Application Data
(60) Provisional application No. 63/639,557, filed on Apr. 26, 2024.

(51) Int. Cl. H04B 7/06; H04B 1/00; H04W 56/00

(52) U.S. Cl. CPC H04B 7/0617; H04B 1/0007; H04B 1/0096; H04W 56/004

(57) ABSTRACT

A system for beamforming and filtering. In some embodiments, the system includes an array of antenna elements; and a front-end circuit connected to the antenna elements, the front-end circuit including a plurality of delay elements. The delay elements may be configured to provide beam forming; and to operate as delay elements in a finite impulse response filter.

### CROSS-REFERENCE TO RELATED APPLICATION(S)

The present application claims priority to and the benefit of U.S. Provisional Application No. 63/639,557, filed Apr. 26, 2024, entitled “PHASED ARRAY TRANSCEIVERS WITH SIMULTANEOUS SPATIAL AND FREQUENCY FILTERING”, the entire content of which is incorporated herein by reference.

### FIELD

One or more aspects of embodiments according to the present disclosure relate to electromagnetic transceivers, and more particularly to a phased array transceiver with simultaneous spatial and frequency filtering.

### BACKGROUND

Phased array antennas have various applications, including as beamforming antennas in radio frequency transceivers, in which they may be used, for example to perform adjustable beamforming and beam steering. Radio transceivers may also include frequency-domain filtering, for example, to suppress interference in a received signal.

It is with respect to this general technical environment that aspects of the present disclosure are related.

### SUMMARY

According to an embodiment of the present disclosure, there is provided a system, including an array of antenna elements; and a front-end circuit connected to the antenna elements, the front-end circuit including a plurality of delay elements configured: to provide beam forming; and to operate as delay elements in a finite impulse response filter.

In some embodiments, a first delay element of the delay elements is configured to provide beam forming and to operate, concurrently with the beam forming, as a delay element in a finite impulse response filter.

In some embodiments, the system further includes a power combiner, wherein: a first signal, originating in a first antenna element, propagates through a first delay element of the delay elements; a second signal, originating in a second antenna element, propagates through a second delay element of the delay elements; and the Nth signal, originating from Nth antenna element, propagates through an Nth delay element of the delay elements and the power combiner is configured to combine all those signals.

In some embodiments, the system further includes: a first analog to digital converter; a second analog to digital converter; and a processing circuit, wherein: a signal, originating in a first antenna element, propagates through a first delay element of the delay elements; a second signal, originating in a second antenna element propagates through a second delay element of the delay elements; the analog to digital converter is configured to convert the first signal to a first digital signal and to feed the first digital signal to the processing circuit; the second analog to digital converter is configured to convert the second signal to a second digital signal and to feed the second digital signal to the processing circuit; and the processing circuit is configured to combine the first digital signal and the second digital signal.

In some embodiments, the finite impulse response filter is a band-pass filter.

In some embodiments, the band-pass filter has a passband centered on a carrier frequency, and a bandwidth substantially equal to a modulation bandwidth.

In some embodiments, the band-pass filter has a shape factor selected to suppress interference at an interfering frequency.

In some embodiments, a delay element of the plurality of delay elements includes an optical delay line.

In some embodiments, the system further includes a first laser source and a second laser source, a frequency separation between the first laser source and the second laser source being equal to an operating frequency of the array of antenna elements.

In some embodiments, the system further includes a photodetector configured to receive: light from an output of the optical delay line, the light originating from the first laser source, and light from the second laser source, overlapping, on the photodetector, the light from the output the optical delay line.

In some embodiments, method, including: providing beam forming, by a plurality of delay elements of a front-end circuit of a system including the front-end circuit and an array of antenna elements connected to the front-end circuit; and operating, by the delay elements, as delay elements in a finite impulse response filter.

In some embodiments, the method includes concurrently: providing beam forming, by a first delay element of the delay elements, and operating, by the first delay element, as a delay element in a finite impulse response filter.

In some embodiments: the system further includes an combiner, a first signal, originating in a first antenna element, propagates through a first delay element of the delay elements; a second signal, originating in a second antenna element, propagates through a second delay element of the delay elements; and the method further includes combining, by the combiner, the RF signal and the second RF signal, a down conversion mixer after the power combiner and an analog to digital converter.

In some embodiments: the system further includes: a first intermediate frequency analog to digital converter; a second intermediate frequency analog to digital converter; and a processing circuit; a first intermediate frequency signal, originating in a first antenna element, propagates through a first delay element of the delay elements; a second intermediate frequency signal, originating in a second antenna element propagates through a second delay element of the delay elements; and the method further includes: converting, by the first intermediate frequency analog to digital converter, the first intermediate frequency signal to a first digital signal and feeding the first digital signal to the processing circuit; converting, by the second intermediate frequency analog to digital converter, the second intermediate frequency signal to a second digital signal and feeding the second digital signal to the processing circuit; and combining, by the processing circuit, the first digital signal and the second digital signal.

In some embodiments, the finite impulse response filter is a band-pass filter.

In some embodiments, the band-pass filter has a passband centered on a carrier frequency, and a bandwidth substantially equal to a modulation bandwidth.

In some embodiments, the band-pass filter has a shape factor selected to suppress interference at an interfering frequency.

In some embodiments, a delay element of the plurality of delay elements includes an optical delay line.

In some embodiments: the system further includes: a first laser source, a second laser source, and a photodetector; a frequency separation between the first laser source and the second laser source is equal to an operating frequency of the antenna elements; and the method further includes receiving, by the photodetector: light from an output of the optical delay line, the light originating from the first laser source; and light from the second laser source, overlapping, on the photodetector, the light from the output the optical delay line.

In some embodiments, the method further includes: numerically determining a plurality of gain coefficients and delay coefficients to maximize an objective function, the objective function including a measure of beam quality and a measure of the quality of the frequency response of the finite impulse response filter; configuring the delay elements to implement the delay coefficients; and configuring a plurality of variable gain elements to implement the gain coefficients.

### BRIEF DESCRIPTION OF THE DRAWINGS

These and other features and advantages of the present disclosure will be appreciated and understood with reference to the specification, claims, and appended drawings wherein:

FIG. 1 is a phase-array system, according to an embodiment of the present disclosure;

FIG. 2 is a phase-array system, according to an embodiment of the present disclosure;

FIG. 3 is a phase-array system, according to an embodiment of the present disclosure;

FIG. 4A is a phase-array system, according to an embodiment of the present disclosure;

FIG. 4B is a phase-array system, according to an embodiment of the present disclosure;

FIG. 5 is a finite impulse response filter, according to an embodiment of the present disclosure;

FIG. 6A is a phase-array system, according to an embodiment of the present disclosure;

FIG. 6B is a phase-array system, according to an embodiment of the present disclosure;

FIG. 7A is a phase-array system, according to an embodiment of the present disclosure; and

FIG. 7B is a phase-array system, according to an embodiment of the present disclosure.

### DETAILED DESCRIPTION

The detailed description set forth below in connection with the appended drawings is intended as a description of exemplary embodiments of a phased array transceivers with simultaneous spatial and frequency filtering provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

A radio receiver may recover the data from the carrier signal and provide amplification and filtration before analog-to-digital conversion, which is the process of digitization for further processing in the digital domain. The bandwidth of the data, which is modulated on top of the carrier signal, may be a fraction of the carrier frequency. A receiver, therefore, may down-convert the modulated signal once received at the antenna to remove the carrier from the data and to bring the frequency of the signal to an intermediate frequency (IF) for further amplification and for conversion to digital form. The circuit responsible for all these operations from the antenna to the intermediate frequency may be referred to as the radio frequency (RF) front-end and is perhaps one of the most important parts of a radio receiver, which may also be challenging to construct. Various architectures may be employed for the implementation of an RF front-end. However, the operations of amplification and down-conversion are often included and the circuit performing these functions may be referred to as the receiver front-end.

Some architectures may use direct RF to digital conversion for directly sampling the received RF signal. Although direct sampling architectures may have the greatest need for tunable front-end filters for noise and interference filtering, any other receiver architecture may also require a filter and the functionality of such a receiver may be significantly enhanced by a tunable and adaptive filter. This may enable reconfigurable transceivers to accommodate several applications with programmable hardware.

Phased array transmitter and receiver circuits in any form or topology may include parallel transmit and receive chains that may also be considered as multiple-input and multiple-output (MIMO) or multiple-input-single-output (MISO) structures and that may be capable of beamforming and electronic beam steering. These topologies may be implemented in various forms for various applications or for various performance metrics. A phased array transceiver system may be configured to provide delay equalization of the received signals from different antenna elements. Due to the physical placement of the antenna elements, a signal received from a direction oblique to the antenna may arrive at some antenna elements earlier than at other antenna elements. Therefore, a phased array transceiver may include time delay or phase shifter components to adjust for the delay mismatch between the antenna elements for constructive combination of the signals later in the receiver or transmitter chain. Depending on the angle of waves incident on the antenna array, the delay on the signals received by the antenna elements varies. As a result, the delay equalization may be angle dependent, or the delay arrangements may enable signals from certain directions to be received in a phased array system while suppressing receiving the signals from other directions.

As such, tunable delay lines may be important blocks for the operation of a phased array system. Phase shifter components may also be used, because over a narrow bandwidth around the carrier, the effect of a phase shifter 120 may approximate that of a delay component; as such, these components may be used interchangeably in narrowband systems.

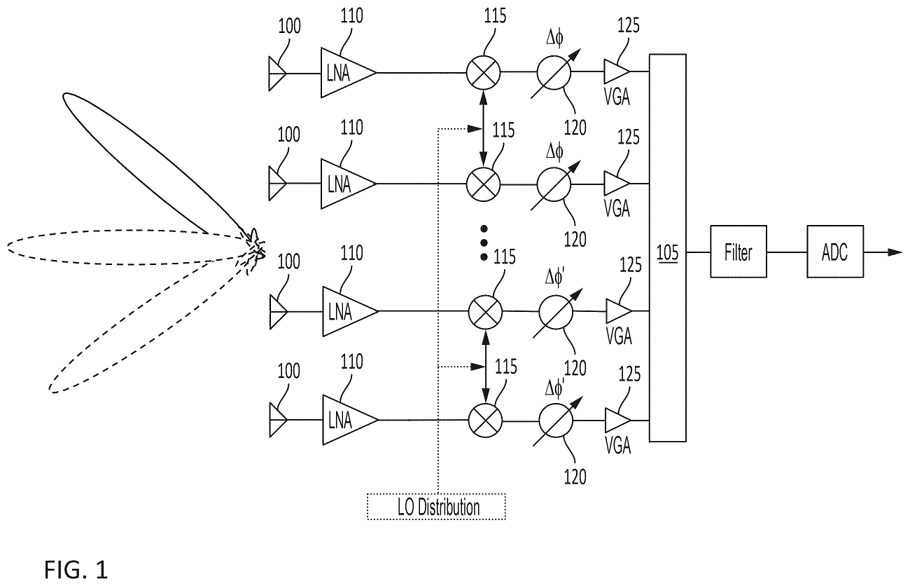

FIG. 1 shows an example implementation of a phased array receiver, in some embodiments. Each antenna element 100 feeds a respective low noise amplifier (LNA) 110, the output of which is connected to a mixer 115, which down-converts the received signal to an intermediate frequency (IF). The phase and amplitude control circuit includes a phase shifter 120 (AQ) and a variable gain element (e.g., a variable gain amplifier (VGA)) 125; in the embodiment of FIG. 1, phase and amplitude control is performed at IF. The (IF) outputs of all of the mixers 115 are then combined, in a combiner (e.g., an IF combiner) 105.

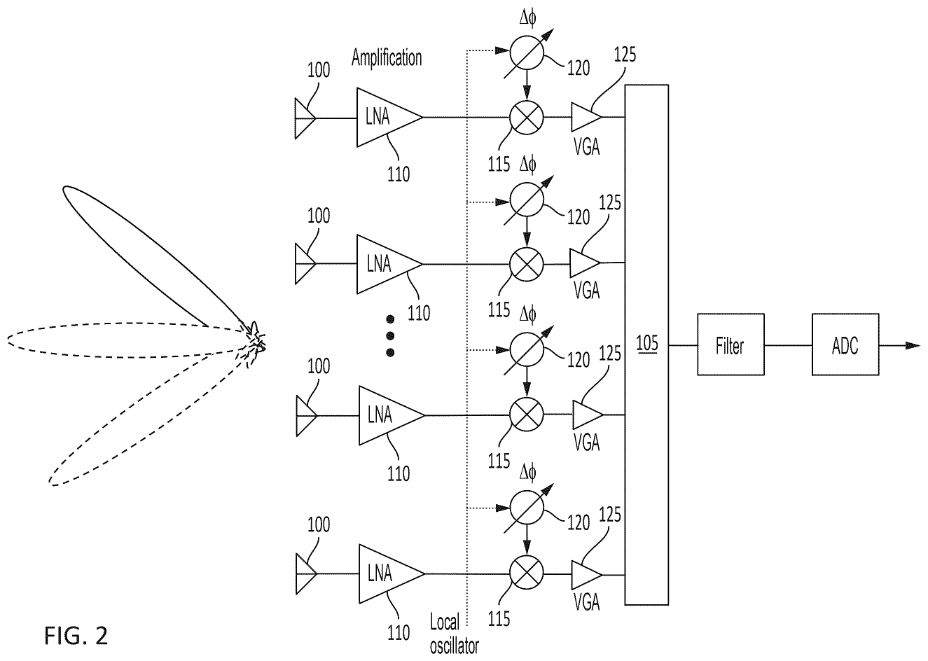

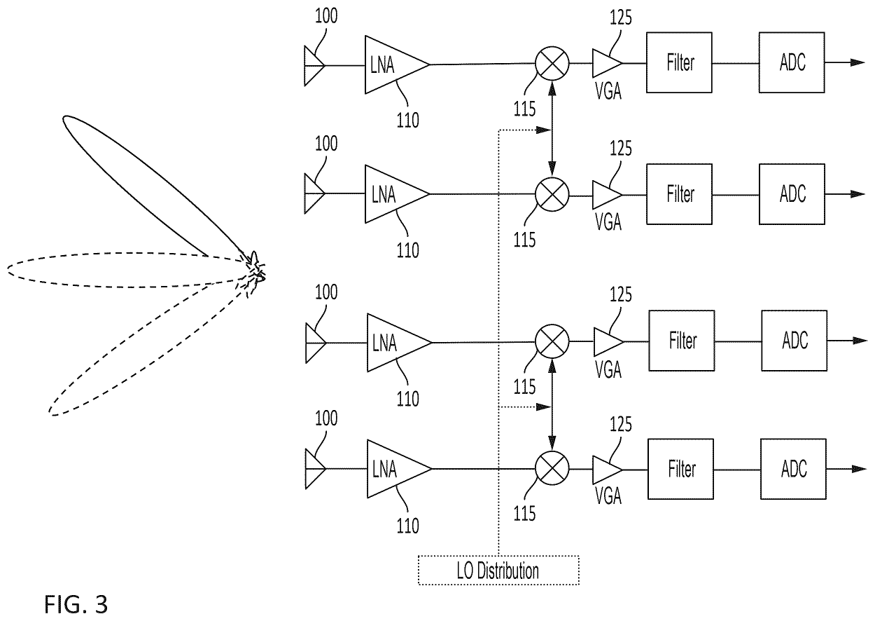

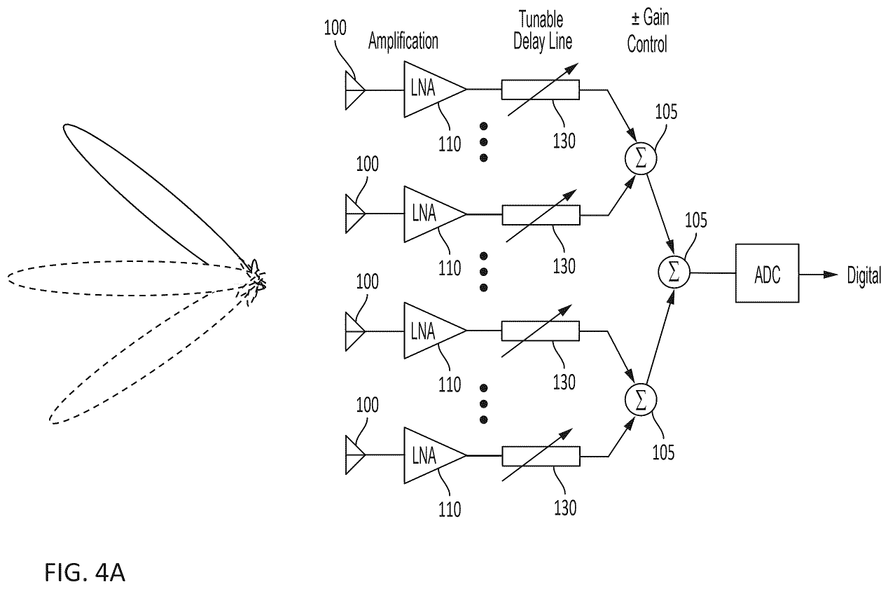

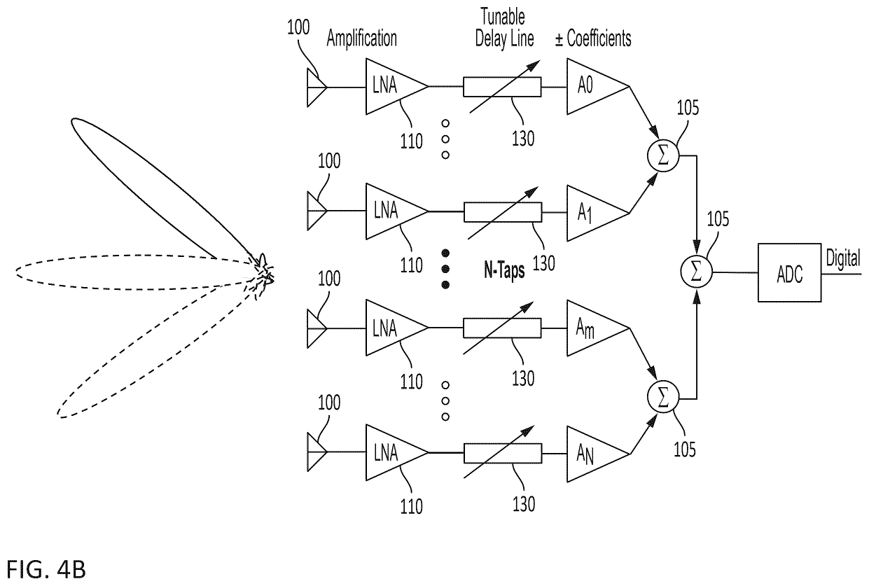

FIG. 2 shows a phased array receiver, in another embodiment. As in the embodiment of FIG. 1, each antenna element 100 feeds a respective low noise amplifier (LNA) 110, the output of which is connected to a mixer 115, which down-converts the received signal to an intermediate frequency (IF). In the embodiment of FIG. 2 phase control is performed by adjusting the phase of the local oscillator (LO) at each mixer 115. FIG. 3 shows an embodiment in which the beam forming is performed in the digital domain, e.g., after each IF signal has been converted to a respective corresponding digital signal by a respective analog to digital converter (ADC). FIG. 4A shows another embodiment where the beamforming is implemented in RF and there is only one digitizer required for this architecture. Other embodiments as the hybrid approaches or the combination of those mentioned here may be implemented, but the concept remains the same regardless of the topology. FIG. 4B shows a system similar to that of FIG. 4A, with variable gain elements 125 (e.g., variable gain amplifiers 125) in one or more of the signal paths from the antenna elements 100 to the combiners 105.

Generally, a phased array system (such as the system of FIG. 3) may be considered to be a multiple-input multiple-output system (e.g., receiver, a transmitter, or a transceiver) for wireless applications. In some embodiments, such a system may simultaneously provide frequency filtering and spatial filtering. Some embodiments have an architecture that allows adaptive filtering based on a finite-impulse-response filter, with utilization of the phased array components and reuse of delay lines that may be inherently present in phased array systems. The tunable filters on the front end are important components that may enable wideband transceiver applications as well as direct RF to digital transceiver systems. Such an embodiment may allow high-speed data reception and transmission, and digitization with enhanced flexibility, reconfigurability, and functionality that allows receive operation for wideband data detection and that enables the receiver to perform adaptive reconfiguration to accommodate various applications and application requirements in terms of dynamic range and linearity. In addition, the beam shape may be corrected for side lop suppression, beam squinting issues, or other type of beam engineering.

Some embodiments provide a wideband and reconfigurable RF system that can support a variety of applications using the same hardware and utilizing programmability and reconfigurability to support the requirements of each application. Such a system may include a tunable front-end filter that can pass the desired frequency band while stopping undesired signals (e.g., interference) and noise at other bands. In such a system, tunability of the filter may provide significant flexibility and performance enhancement for transceiver operation. The reconfigurable filtering also allows the adaptive operation of the receiver at various frequencies and bands while eliminating the noise, interference and aliasing issues.

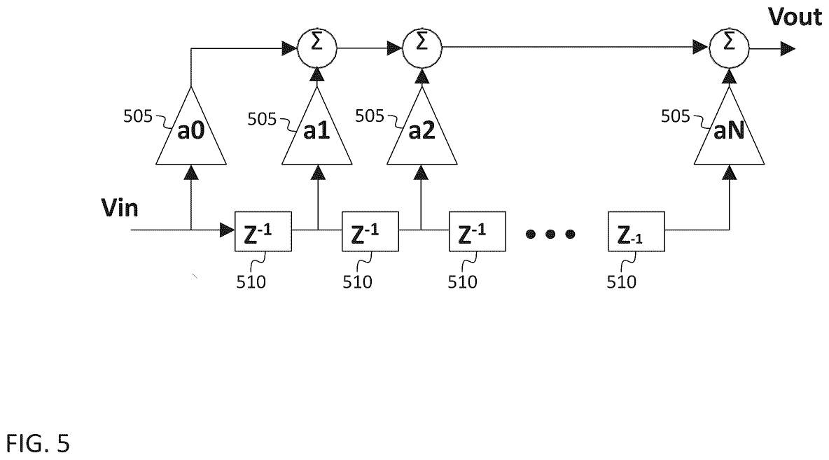

Some embodiments take advantage of the inherent capability of phased array systems in providing parallel receive paths and tunable delay lines, and use these components to synthesize a tunable finite-impulse-response (FIR) filter. In a FIR filter, such as the one illustrated in FIG. 5, the frequency response of the filter is determined by the coefficients 505 and z⁻¹ components 510 which are digital single delay elements.

In some embodiments, a delay element is implemented using an analog delay element such as true-time delay implemented by transmission lines or LC-based delay elements or optical delay line (which may have lower loss than electrical delay lines). In some embodiments, the transmitter or the receiver operate in the optical domain and perform optical phased array functionality with optical delays. In other embodiments the RF or IF signal to be delayed may be converted to an optical signal and the converted optical signal may be fed into the optical delay line. The output of the optical delay line may then be converted back to RF or IF frequency by optical receivers.

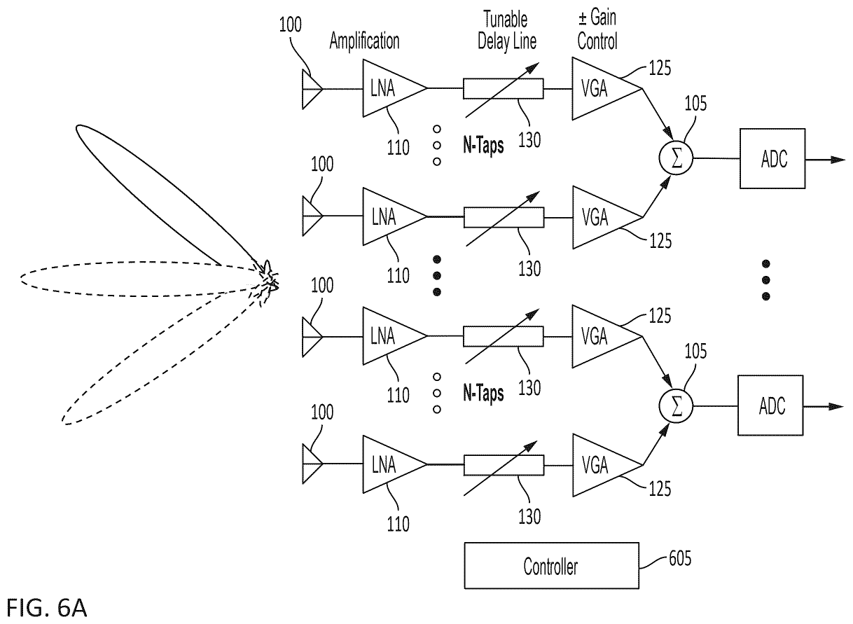

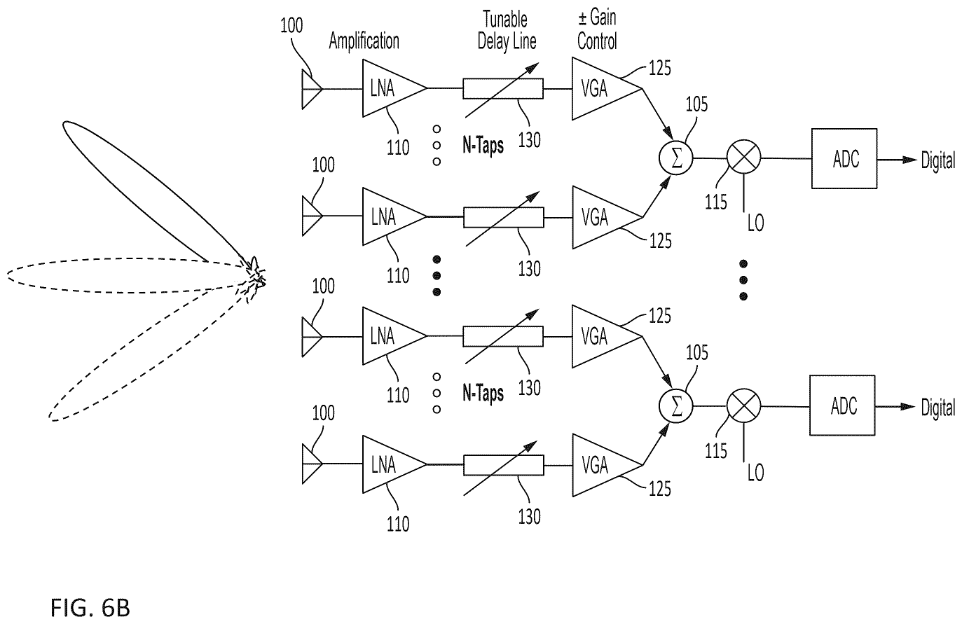

An analog FIR filter may use the same architecture with analog delay elements and coefficients implemented as amplifiers or attenuators to synthesize one or more filter responses. Some embodiments utilize the inherent delay lines in the phased array transceiver system (that may also be used for delay equalization between the antenna elements 100) and reconfigure this set of delay lines to synthesize an FIR filter. One architecture for such a structure is shown in FIG. 6A. In the embodiment of FIG. 6A, the variable gain amplifiers 125 operate as the coefficients of the FIR filter. The delay lines may be adjusted to operate as the delay equalizers of the antenna array. For instance, the channel for which the signal (from a direction oblique to the antenna) arrives with the longest delay path may be considered the shortest branch (a0) of the FIR filter of FIG. 5. In such an embodiment, the proper adjustments of the delay lines and coefficients enable the realization of simultaneous delay equalization and of a FIR function. To tune the filter, the VGA gain elements and adjustable delay lines may be adjusted to tune the center frequency and the bandwidth. Such a dual use of the delay elements and the variable gain elements (for both beam forming and to implement a FIR filter for frequency domain filtering) may be implemented in a phased array receiver, in a phased array transmitter, or in a phased array transceiver. FIG. 6B shows a system similar to that of FIG. 6A, with, in the system of FIG. 6B, down-conversion to an intermediate frequency (IF) being performed before analog-to-digital conversion.

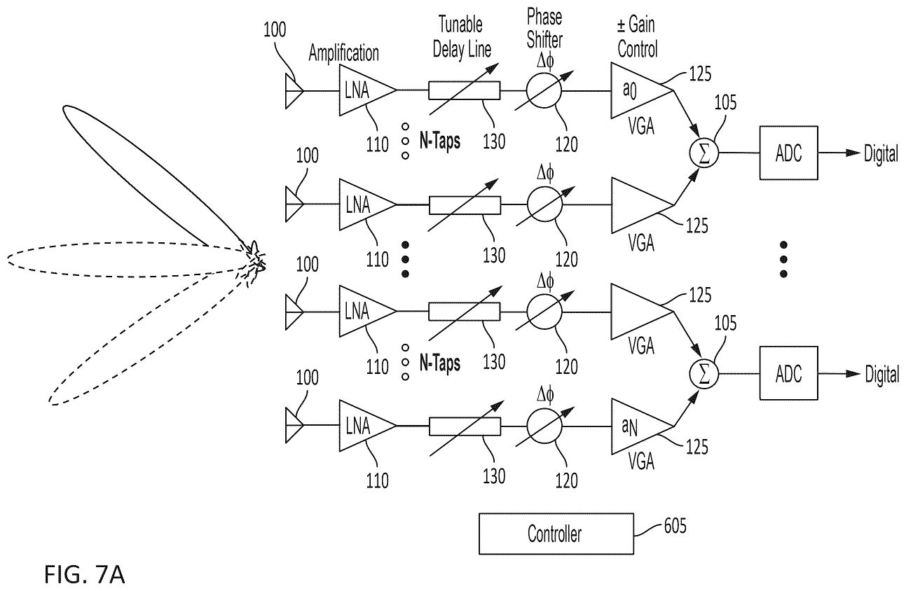

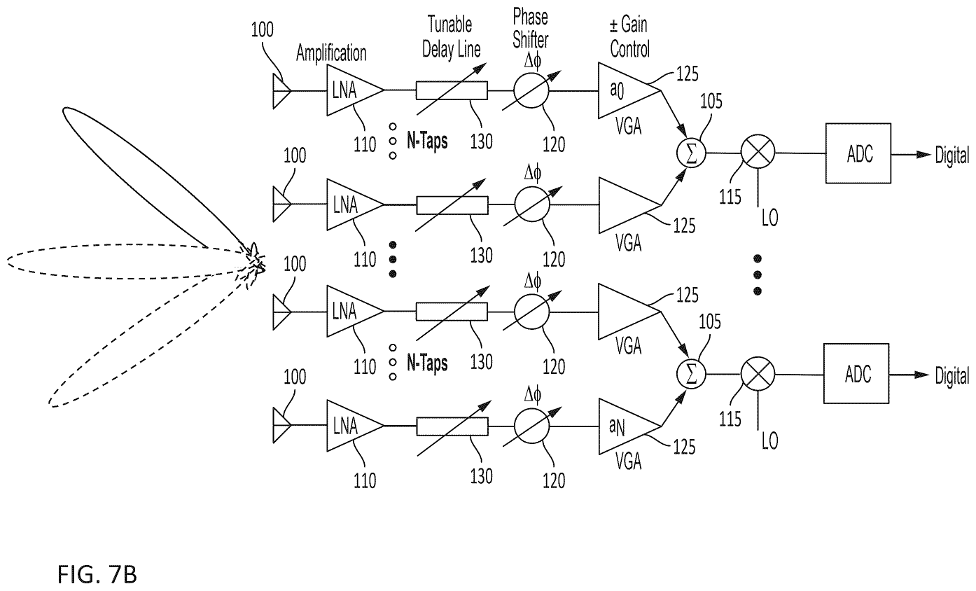

The variable gain elements 125 may be variable gain amplifiers 125 (as mentioned above) or variable attenuation attenuators, or elements capable of being configured to provide either attenuation or gain. As used herein, a “variable gain element” is capable of providing variable gain, or variable attenuation, or both, under the control of an electronic control signal, which may be produced by an antenna controller 605 (which may be or include a processing circuit). In some embodiments, phase shifters 120 are also included (e.g., as illustrated in FIG. 7A), to correct the beam shape as needed. The phase shifters 120 may introduce negligible delay, and, as such, may not impact the operation of the synthesized FIR filter, but equalize and correct the beam shape as needed. In FIG. 7A, if desired a single ADC may be used instead of using multiple ADCs; for such an operation all the channels may be summed up before the ADC and fed to a single ADC for digitization. In each embodiment described herein, each delay element may be fixed (e.g., it may provide a delay that does not change) or variable (e.g., it may be controllable, e.g., under the control of an electronic control signal, which may be produced by the antenna controller 605). Similarly, each gain element of an embodiment described herein may be fixed (e.g., it may provide a gain or attenuation that does not change) or variable (e.g., it may be controllable, e.g., under the control of an electronic control signal, which may be produced by the antenna controller 605). FIG. 7B shows a system similar to that of FIG. 7A, with, in the system of FIG. 7B, down-conversion to an intermediate frequency (IF) being performed before analog-to-digital conversion. A controller 605 is shown in only some of the drawings but may be present in any embodiment.

As used herein, a “gain element” may provide a gain of more or less than 0 dB (e.g., it may provide attenuation), and, as such, an attenuator is an example of a gain element as the term “gain element” is used herein. In some embodiments, two gain elements may have gain of opposite signs, e.g., a first gain element may incorporate a noninverting amplifier and a second gain element may incorporate an inverting amplifier, e.g., the second gain element may have a gain differing in sign from a gain of the first gain element. In each embodiment described herein, the elements of the phased array antenna may be arranged in one dimension (e.g., along a straight line, or along a curved line) or in two dimensions (e.g., across a plane, or curved surface).

In some embodiments, gain and delay coefficients may be chosen to concurrently (e.g., simultaneously) achieve a desired beam pattern (e.g., a narrow, high-gain beam, with small side lobes, aimed in a first direction (the direction to a signal source transmissions from which the system is configured to receive)) and a desired FIR filter frequency response (e.g., a band-pass filter centered on the carrier, with a bandwidth substantially equal to a modulation bandwidth (e.g., to the spectral width of the modulated carrier), or any desired bandwidth reconfigurable with the implemented FIR filter by choosing appropriate coefficients and delay choices). In some embodiments, the shape factor of the FIR filter is selected to suppress interference at a particular frequency (e.g., at a frequency at which a known source of interference is expected to radiate).

In some embodiments, the respective gains and delays of the gain elements and the delay elements are selected so as to provide interference suppression for the main beam of the antenna. For example, the receiving frequency response of the antenna system for a signal arriving from a direction centered on the main beam may have a bandpass frequency response (e.g., centered on a frequency of operation), so that an interfering source from which waves arrive from the same direction, which transmits at a frequency outside of the band of the bandpass filter, is suppressed. Similarly, in some embodiments, the receiving frequency response of the antenna system for a signal arriving from a direction centered on the main beam may have a notch filter frequency response, with the notch centered on the (known or expected) frequency of an interfering source, transmitting from the same direction as a desired source.

In some embodiments, the FIR filter frequency response may be or include a band-stop filter centered on a frequency at which a known source of interference is expected to radiate. Such a source of interference may be radiating from the same direction or a second direction, different from the first direction. The FIR filter may be capable of suppressing the interference in either case. If the interference comes from a second direction, the spatial shape of the beam may further suppress the interference; as such, the total delay from the interfering source to the output of, e.g., the intermediate frequency combiner 105, may be different through different signal paths (e.g., through the different VGAs that provide the FIR filter coefficients). The overall combination of the phased array channels may provide additional spatial filtering.

In some embodiments, if the delay and gain coefficients that would result in a certain desired beam shape differ from those that would result in a certain desired FIR filter frequency response, the phase shifters 120 may correct for the beam shape while preserving the FIR response or a compromise set of delay and gain coefficients may be used. Such a compromise set of delay and gain coefficients may be found, for example, by defining an objective function (which may include a measure of the quality of the beam and also a measure of the quality of the FIR filter frequency response); the delay and gain coefficients that maximize the objective function may then be found (e.g., by a suitable numerical optimization method, e.g., a gradient descent method) and used in operation.

In some embodiments, the beamformer and analog FIR filters are realized separately. Some embodiments have several advantages compared to separate implementations of the beamformer and FIR filters. First, the loss and bandwidth limited power distribution between the delay elements are removed and instead the inherent power division of the phased array system may be utilized. This allows significant bandwidth enhancement and loss reduction. Second, the lengthy true-time delay lines that are also bandwidth limited and quite lossy may be reused in the structure instead of including two such sets of delay lines. This technique may be utilized in any multiple-input-multiple-output transceiver systems or parallel channels of transceivers or any other type of transceiver systems.

The tunable filter in the architecture allows (i) the selection of a desired band within a wide bandwidth as desired and (ii) the removing of the undesired signals in other parts of the band when the full bandwidth is not required. For example, for a phased array system that can operate at 10 GHz-50 GHZ, if only a signal in the band extending from 12GHz to 18 GHz is to be used, the filter may pass signals at frequencies between 12 GHz and 18 GHz and block undesired signals at other frequencies. In some embodiments, if the wideband receiver is used for a narrowband application, the filter can remove the undesired signals or the noise. in the absence of such filtering, aliasing resulting from digitization and introduced by the interference or noise from unintended frequencies may interrupt the communication or reduce the signal to noise ratio and the data rate or even block the receiver. The FIR filter may help to reduce these impacts. In some embodiments, the FIR filter can be used for equalization and correction of the beam shape by reducing the sidelobes or grating lobes or the shape of the beam in general. The FIR filter may be used as equalizer in this case.

Some embodiments may significantly improve the performance of direct RF to digital transceiver systems having a need for tunable filters. In some embodiments, the bandwidth and tunability of the front-end filter is significantly enhanced. The loss of the front-end, end, which may impact the dynamic range, is significantly reduced. The layout area may be significantly reduced. All of these characteristics may have favorable implications for tunability performance, power consumption and dynamic range.

Some embodiments may find use in cellular applications for base stations and access points as well as for cellular users (e.g., in user equipment). In addition, some embodiments may have applications in defense communications and radar. Having the possibility of using a wide band and adaptive architecture with improved tunability, enhanced bandwidth, increased dynamic range and reduced power consumption may be advantageous for commercial wireless communications, and for sensing and ranging systems.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAS). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of phased array transceivers with simultaneous spatial and frequency filtering have been specifically described and illustrated herein, many modifications and variations will be apparent to those skilled in the art. Accordingly, it is to be understood that phased array transceivers with simultaneous spatial and frequency filtering constructed according to principles of this disclosure may be embodied other than as specifically described herein. The invention is also defined in the following claims, and equivalents thereof.

What is claimed is:

1. A system, comprising
an array of antenna elements; and
a front-end circuit connected to the antenna elements,
the front-end circuit comprising a plurality of delay elements configured:
to provide beam forming; and
to operate as delay elements in a finite impulse response filter.

2. The system of claim 1, wherein a first delay element of the delay elements is configured to provide beam forming and to operate, concurrently with the beam forming, as a delay element in a finite impulse response filter.

3. The system of claim 1, further comprising a power combiner, wherein:
a first signal, originating in a first antenna element, propagates through a first delay element of the delay elements;
a second signal, originating in a second antenna element, propagates through a second delay element of the delay elements; and
the power combiner is configured to combine the first signal and the second signal.

4. The system of claim 1, further comprising:
a first analog to digital converter;
a second analog to digital converter; and
a processing circuit, wherein:
a first signal, originating in a first antenna element, propagates through a first delay element of the delay elements;
a second signal, originating in a second antenna element propagates through a second delay element of the delay elements;
the first analog to digital converter is configured to convert the first signal to a first digital signal and to feed the first digital signal to the processing circuit;
the second analog to digital converter is configured to convert the second signal to a second digital signal and to feed the second digital signal to the processing circuit; and
the processing circuit is configured to combine the first digital signal and the second digital signal.

5. The system of claim 1, wherein the finite impulse response filter is a band-pass filter.

6. The system of claim 5, wherein the band-pass filter has a passband centered on a carrier frequency, and a bandwidth substantially equal to a modulation bandwidth.

7. The system of claim 6, wherein the band-pass filter has a shape factor selected to suppress interference at an interfering frequency.

8. The system of claim 1, wherein:
a signal path from a first antenna element of the array of antenna elements comprises:
a first delay element of the plurality of delay elements; and
a first gain element of a plurality of gain elements, and
a signal path from a second antenna element of the array of antenna elements comprises:
a second delay element of the plurality of delay elements; and
a second gain element of the plurality of gain elements.

9. The system of claim 8, wherein the second gain element has a gain differing by at least 3 dB from a gain of the first gain element.

10. The system of claim 8, wherein the second gain element has a gain differing in sign from a gain of the first gain element.

11. A method, comprising:
providing beam forming, by a plurality of delay elements of a front-end circuit of a system comprising the front-end circuit and an array of antenna elements connected to the front-end circuit; and
operating, by the delay elements, as delay elements in a finite impulse response filter.

12. The method of claim 11, comprising concurrently:
providing beam forming, by a first delay element of the delay elements, and
operating, by the first delay element, as a delay element in a finite impulse response filter.

13. The method of claim 11, wherein:
the system further comprises an intermediate frequency combiner,
a first intermediate frequency signal, originating in a first antenna element, propagates through a first delay element of the delay elements;
a second intermediate frequency signal, originating in a second antenna element, propagates through a second delay element of the delay elements; and
the method further comprises combining, by the intermediate frequency combiner, the first intermediate frequency signal and the second intermediate frequency signal.

14. The method of claim 11, wherein:
the system further comprises:
a first intermediate frequency analog to digital converter;
a second intermediate frequency analog to digital converter; and
a processing circuit;
a first intermediate frequency signal, originating in a first antenna element, propagates through a first delay element of the delay elements;
a second intermediate frequency signal, originating in a second antenna element propagates through a second delay element of the delay elements; and
the method further comprises:
converting, by the first intermediate frequency analog to digital converter, the first intermediate frequency signal to a first digital signal and feeding the first digital signal to the processing circuit;
converting, by the second intermediate frequency analog to digital converter, the second intermediate frequency signal to a second digital signal and feeding the second digital signal to the processing circuit; and
combining, by the processing circuit, the first digital signal and the second digital signal.

15. The method of claim 11, wherein the finite impulse response filter is a band-pass filter.

16. The method of claim 15, wherein the band-pass filter has a passband centered on a carrier frequency, and a bandwidth substantially equal to a modulation bandwidth.

17. The method of claim 16, wherein the band-pass filter has a shape factor selected to suppress interference at an interfering frequency.

18. The method of claim 11, wherein a delay element of the plurality of delay elements comprises an optical delay line.

19. The method of claim 18, wherein:
the system further comprises:
a first laser source,
a second laser source, and
a photodetector;
a frequency separation between the first laser source and the second laser source is equal to an operating frequency of the antenna elements; and
the method further comprises receiving, by the photodetector:
light from an output of the optical delay line, the light originating from the first laser source; and
light from the second laser source, overlapping, on the photodetector, the light from the output the optical delay line.

20. The method of claim 11, further comprising:
numerically determining a plurality of gain coefficients and delay coefficients to maximize an objective function, the objective function including a measure of beam quality and a measure of quality of the frequency response of the finite impulse response filter;
configuring the delay elements to implement the delay coefficients; and
configuring a plurality of variable gain elements to implement the gain coefficients.
